(19) United States
(12) Patent Application Publication
(10) Pub. No.: US 2026/0240149 A1
(43) Pub. Date: Aug. 20, 2026

(54) Solid formulation of insecticidal mixtures having particularly good dispersion properties

(71) Applicant: BAYER AKTIENGESELLSCHAFT, Leverkusen (DE)

(72) Inventors: Holger Egger, Köln (DE); Laura Zumsande, Leverkusen (DE)

(73) Assignee: Bayer AG, Leverkusen (DE)

(21) Appl. No.: 18/881,805

(22) PCT Filed: Jul. 5, 2023
(86) PCT No.: PCT/EP2023/068582

§ 371 Date: Jan. 7, 2025

(30) Foreign Application Priority Data
Jul. 8, 2022 (EP) 22183985.5

(51) Int. Cl. A01N 25/14; A01N 25/00; A01N 25/10; A01N 25/30; A01N 43/36; A01N 59/04; A01N 59/26

(52) U.S. Cl. CPC A01N 25/14; A01N 25/006; A01N 25/10; A01N 25/30; A01N 43/36; A01N 59/04; A01N 59/26

(57) ABSTRACT

The invention relates to solid-state formulations (especially water-dispersible granules) of tetramic acid derivatives and mixtures of these tetramic acid derivatives that break down particularly efficiently in water and nevertheless have good long-term stability, and to a process for production thereof and to the use thereof for application of the active ingredients present.

The invention relates to solid-state formulations (especially water-dispersible granules) of tetramic acid derivatives and mixtures of these tetramic acid derivatives that break down particularly efficiently in water and nevertheless have good long-term stability, and to a process for production thereof and to the use thereof for application of the active ingredients present.

The production of WG formulations with the formulation auxiliaries specified in the prior art leads to formulations having unwanted properties. For instance, the proportion of insoluble ingredients or the presence of some active ingredients can have the effect that the granules, after introduction into water, break down poorly (i.e. incompletely or too slowly) or dissolve poorly. The slow breakdown of the granules can then have the effect that sediment remains, nozzles become blocked, or the concentration of the active ingredient in the spray liquor and the associated efficacy is reduced.

WO2019197631 describes water-dispersible granules of tetramic acid derivatives and mixtures of these tetramic acid derivatives. However, this does not describe additives explicitly intended to improve dissolution properties.

US2015/0164068 describes storage-stable WG formulations having good efficacy that contain the active ingredient in different particle sizes and a less hygroscopic water-soluble carrier at 75% by weight in the form of an inorganic salt. Preferred carriers mentioned are ammonium sulfate and potassium sulfate, while potassium hydrogencarbonate is listed merely in general terms as a carrier without an example in a relatively long list. Furthermore, there is no disclosure of the explicit use of potassium hydrogencarbonate in the examples.

By contrast with US2015/0164068, potassium hydrogencarbonate is present in the present compound only in a distinctly smaller amount and, particularly in conjunction with a further basic salt, can lead to reactions and adverse effects on storage stability.

WO2020/240394 describes WG formulations including a “disintegration system”. These also include inorganic salts, including hydrogencarbonates. In that case, however, there is no further potentially decomposable salt present in the formulation, and so no adverse effects on storage stability are to be expected. Furthermore, there is also no disclosure here of the explicit use of potassium hydrogencarbonate in the examples; instead, the standard potassium sulfate is used.

Furthermore, the general use of hydrogencarbonates in dissolving tablets in conjunction with acids, e.g. citric acid, is known.

It has now been found that, surprisingly, the present formulations have particularly advantageous properties with regard to storage stability and rapid dissolution.

It has been found that, surprisingly, the addition of a particular amount of inorganic carbonate salt, especially hydrogencarbonates, ensures that the granules dissolve more quickly and better without adversely affecting the storage stability of the granules (especially also at elevated temperature), even in the presence of a basic ammonium salt.

It is a further feature of the formulations of the present invention that they also have good suspendability even at a high salt load, especially also after storage.

Accordingly, these formulations form the subject-matter of the present invention. The present invention further relates to a process for producing these water-dispersible granules and to the use thereof for application.

The invention therefore provides insecticidal solid-state compositions in the form of water-dispersible granules (solid-state formulations), preferably comprising:
a. as component a tetramic acid derivatives of the formula (I)

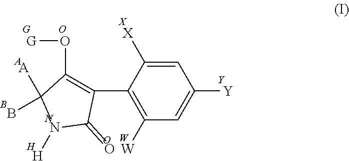

in which
W and Y are independently hydrogen, C1-C4-alkyl, chlorine, bromine, iodine or fluorine,
X is C1-C4-alkyl, C1-C4-alkoxy, chlorine, bromine or iodine,
A, B and the carbon atom to which they are bonded are C3-C6-cycloalkyl substituted by an optionally C1-C4-alkyl- or C1-C4-alkoxy-C1-C2-alkyl-substituted alkylenedioxyl group that forms a 5-membered or 6-membered ketal together with the carbon atom to which it is bonded,
G is hydrogen (a) or is one of the groups

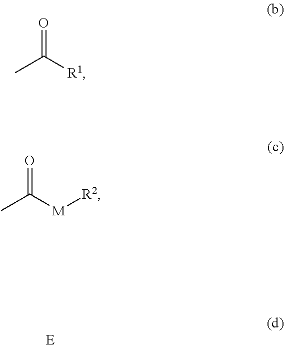

in which
E is a metal ion or an ammonium ion,
M is oxygen or sulfur,
R1 is straight-chain or branched C1-C6-alkyl,
R2 is straight-chain or branched C1-C6-alkyl,
b. at least one basic salt,
c. at least one further inorganic salt from the group of the carbonates and hydrogencarbonates, with exclusion of ammonium as cation. Unless explicitly included, ammonium salts of the carbonates and hydrogencarbonates are always excluded in the present invention as component c).
d. at least one dispersant,
e. at least one wetting agent,
f. at least one filler,
g. optionally a structure former,
h. optionally further active ingredients, and
i. optionally further customary adjuvants and formulation auxiliaries.

In the present invention, in formulae, e.g. formula (I), optionally substituted radicals, unless stated otherwise, may be mono- or polysubstituted, where the substituents in the case of polysubstitutions may be the same or different.

Moreover, in ranges of preference stated in the present invention, the different levels of preference should be understood such that they can be combined with one another in permutations, but in any case identical levels of preference and especially the most preferred embodiment/level of preference in each case are to be combined with one another and are indeed disclosed as such a combination.

Compositions as described above that consist solely of the essential components (not optional components) should likewise be considered to be disclosed.

Percentages-unless stated otherwise-should be regarded as percentages by weight, where the % by weight of the compositions add up to 100.

Unless defined differently, “basic” in the context of the present invention means a pH in aqueous solution with pH>7.

The formulations according to the invention in aqueous dispersion have a pH of >7.

In a preferred embodiment, the formulations contain at least one defoamer (i), preferably in solid form, preferably based on silicone oil or wax, further preferably a PDMS adsorbed on a solid support.

The preferred defoamer is: Rhodorsil antifoam EP6703 (absorbed polydimethylsiloxane).

### a) Active Ingredient

In a preferred embodiment, component a) in the compositions according to the invention is a compound of the formula (I)

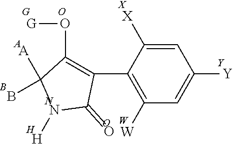

where the compounds of the formula (I) have the following definitions:
W is methyl,
X is chlorine or methyl,
Y is chlorine, bromine or methyl,
A, B and the carbon atom to which they are bonded are saturated C6-cycloalkyl substituted by an alkylenedioxyl group that forms a 5-membered or 6-membered ketal together with the carbon atom to which it is bonded,
G is hydrogen (a) or is one of the groups

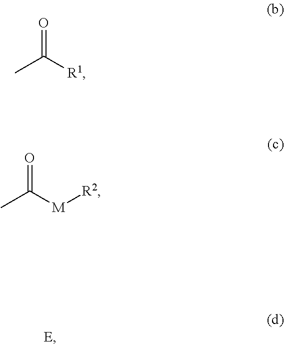

in which
M is oxygen,
E is one metal ion equivalent or an ammonium ion,
R¹ is straight-chain or branched C₁-C₄-alkyl,
R² is straight-chain or branched C₁-C₄-alkyl.

In a further-preferred embodiment, component a) in the compositions according to the invention is a compound of the formula (I)

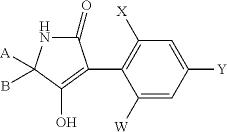

(I) with

| | | | | |
|---|---|---|---|---|
| W | X | Y | A | B |

| | | | |
|---|---|---|---|
| CH₃ | CH₃ | CH₃ | 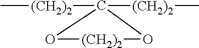 |
| CH₃ | CH₃ | Cl | 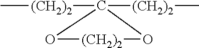 |
| CH₃ | CH₃ | Br | 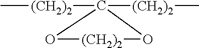 |
| CH₃ | CH₃ | CH₃ | 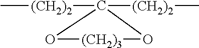 |
| CH₃ | CH₃ | Cl | 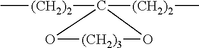 |
| CH₃ | CH₃ | Br | 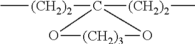 |

In a particularly preferred embodiment, component a) is a compound of the formula

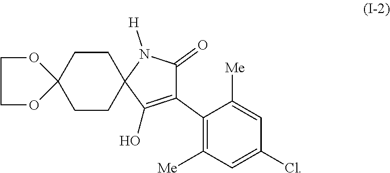 [SMILES: Cc1cc(Cl)cc(C)c1C1=C(O)C2(CCC3(CC2)OCCO3)NC1=O]

### b) Basic Salt

Component b) is preferably selected from the group comprising inorganic basic ammonium salts, excluding carbonates and hydrogencarbonates. In the context of the invention, the basic salt b), unless explicitly mentioned otherwise, is not a carbonate.

Further preferably, b) is selected from the group comprising diammonium hydrogenphosphate (DAHP).

c) A further inorganic salt selected from the group comprising inorganic carbonates and hydrogencarbonates, excluding the ammonium salts thereof.

Further preferably, c) is selected from the group of the hydrogencarbonates.

Particular preference is given to sodium hydrogencarbonate and potassium hydrogencarbonate.

### d) Dispersants

Suitable dispersants in the context of the present invention are dispersants of the polycarboxylate type, for example those such as hydrophobically modified comb-like polymers, for example polyacrylic acid, polymethacrylic acid, polymaleic acid, polymaleic anhydride, a copolymer of maleic acid or maleic anhydride with an olefin (such as isobutylene or diisobutylene), a copolymer of acrylic acid and itaconic acid, a copolymer of methacrylic acid and itaconic acid, a copolymer of maleic acid or maleic anhydride and styrene, a copolymer of acrylic acid and methacrylic acid, a copolymer of acrylic acid and methacrylate, a copolymer of acrylic acid and vinyl acetate, a copolymer of styrene and methacrylic acid, modified copolymers of styrene and methacrylic acid, a copolymer of maleic acid or maleic anhydride and acrylic acid, an N-methyl fatty acid (e.g. C₈-C₁₈)-sarcosinate, a carboxylic acid such as a resin acid or a fatty acid (e.g. C₈-C₁₈) or a salt of such a carboxylic acid, for example alkali metal or alkaline earth metal salts (preferably Ca, Mg). The abovementioned copolymers may also be in the form of their salts, e.g. alkali metal salts (preferably Li, Na, K), alkaline earth metal salts (preferably Ca, Mg), ammonium or various amines.

Further preferred are dispersants from the group comprising sodium salts of the copolymers of maleic acid and olefins (e.g. Geropon T/36/Solvay; Duramax D-305/Dow); and sodium salts of copolymers of methacrylic acid and styrene (Tersperse 2700/Indorama; Atlox Metasperse 500S/Croda).

The dispersant is more preferably a sodium salt of copolymers of methacrylic acid and styrene.

Particular preference is given to the additional addition of stearates, especially magnesium stearate.

### e) Wetting Agents

Useful nonionic surfactants include all substances of this type which are typically usable in agrochemical compositions. Preferably mention may be made of polyethylene oxide-polypropylene oxide block copolymers, polyethylene glycol ethers of linear alcohols, reaction products of fatty acids with ethylene oxide and/or propylene oxide, and also polyvinyl alcohol, polyvinylpyrrolidone, copolymers of polyvinyl alcohol and polyvinylpyrrolidone, and copolymers of (meth)acrylic acid and (meth)acrylic esters, and additionally alkyl ethoxylates and alkylaryl ethoxylates, which optionally may be phosphated and optionally may be neutralized with bases, mention being made, by way of example, of sorbitol ethoxylates, and also polyoxyalkyleneamine derivatives.

Suitable anionic surfactants include all substances of this type that can typically be used in agrochemical compositions.

Useful wetting agents are preferably anionic surfactants selected from the group comprising salts of polystyrenesulfonic acids, salts of polyvinylsulfonic acids, salts of naphthalenesulfonic acid-formaldehyde condensation products, salts of condensation products of naphthalenesulfonic acid, phenolsulfonic acid and formaldehyde, and salts of lignosulfonic acid and sodium salts of alkylated naphthalenesulfonates, for example®Morwet EFW, and the sodium salts of dioctylsulfosuccinic acid, for example®Aerosol OTB, Geropon® SDS, and block polymer of propylene oxide and ethylene oxide on ethylenediamine, for example®Synperonic T 905.

More preferably, suitable wetting agents (e) in the context of the present invention are selected from the group consisting of the sodium salts of alkylated naphthalenesulfonates, for example®Morwet EFW, and the sodium salts of dioctylsulfosuccinic acid, for example®Aerosol OTB, Geropon® SDS.

### f) Filler

Useful inert filler materials are all substances typically usable for this purpose in agrochemical compositions. Preference is given to inorganic particles, such as silicates and oxides, and also organic substances, such as urea-formaldehyde condensates and celluloses (e.g. Ulmerweiss 6AL, Celite 209, Argirec B21 and B22, Bentone E W, Luz2 talc, Etiquette Violette). Examples include kaolin, rutile, silicon dioxide, finely divided silica, silica gels, and natural and synthetic silicates, and also talc.

The filler is further preferably selected from the group comprising kaolin, rutile and silicon dioxide. Particular preference is given to kaolin.

### g) Structure Formers

The formulations according to the invention may further comprise a structure former. Suitable for this purpose are particularly polyacrylic acid and salts thereof and especially crosslinked polyacrylates, and also polyurethanes and derivatized polyurethanes and salts thereof. Examples of such suitable acrylates are: (poly)methacrylate, (poly)methylmethacrylate, polyacrylamide, (poly)ethoxyethylmethacrylate, and polymethylurea resins, e.g. Pergopak®M.

The structure former is more preferably a polymethylurea resin.

### h) Further Active Ingredients

The formulation may in principle comprise one or more further active agrochemical ingredients, preferably selected from the group of the insecticides, herbicides, fungicides and host defence inductors.

Further preferred active ingredients are one or more selected from the group of the insecticides, even further preferably from the group comprising imidacloprid, nitenpyram, acetamiprid, thiacloprid, thiamethoxam, clothianidin, cyantraniliprole, chlorantraniliprole, deltamethrin, flubendiamid, tetraniliprole, cyclaniliprole; spirodiclofen, spiromesifen, spirotetramat, abamectin, acrinathrin, chlorfenapyr, emamectin, ethiprole, fipronil, flonicamid, flupyradifuron, indoxacarb, metaflumizone, methoxyfenozid, milbemycin, pyridaben, pyridalyl, silafluofen, spinosad, spinetoram, sulfoxaflor, triflumuron.

Particular preference is given to one or more further active ingredients selected from the group comprising ethiprole, spinetoram, abamectin and flupyradifurone.

### i) Adjuvants and Formulation Aids

Useful foam inhibitors are all substances typically usable for this purpose in agrochemical compositions.

Preference is given to silicone oil-based defoamers and magnesium stearate.

Preference is further given to solid defoamers, or to defoamers adsorbed or absorbed onto a support.

Particular preference is given to polydimethylsiloxane absorbed on a solid substrate. One example is Rhodorsil antifoam EP 6703.

Useful preservatives include all substances which are typically usable for this purpose in agrochemical compositions of this type. Examples include isothiazolinone (e.g. Preventol® (from Lanxess AG)) and 1,2-benzisothiazolin-3-one (e.g. Proxel®).

Useful antioxidants are all substances typically usable for this purpose in agrochemical compositions. Preference is given to butylhydroxytoluene.

Useful dyes are all substances typically usable for this purpose in agrochemical compositions. Examples include titanium dioxide, pigment black, zinc oxide and blue pigments, and also Permanent Red FGR.

In a preferred embodiment, the invention provides an insecticidal solid-state composition in the form of water dispersible granules comprising:
a. Compounds of the Formula (I)

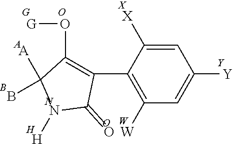

where the compounds of the formula (I) have the following definitions:
W is methyl,
X is chlorine or methyl,
Y is chlorine, bromine or methyl,
A, B and the carbon atom to which they are bonded are saturated C₆-cycloalkyl substituted by an alkylenedioxyl group that forms a 5-membered or 6-membered ketal together with the carbon atom to which it is bonded,
G is hydrogen (a) or is one of the groups

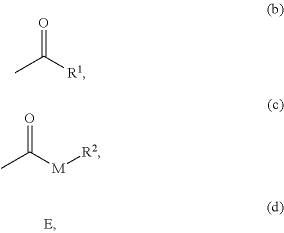

in which
M is oxygen,
E is one metal ion equivalent or an ammonium ion,
R¹ is straight-chain or branched C₁-C₄-alkyl,
R² is straight-chain or branched C₁-C₄-alkyl.

### (I)

b. at least one inorganic basic ammonium salt,
c. a further inorganic salt selected from the group of the carbonates and hydrogencarbonates,
d. at least one dispersant of the polycarboxylate type,
e. at least one anionic wetting agent,
f. at least one inert filler,
g. optionally a structure former,
h. optionally further active insecticidal ingredients,
i. optionally further adjuvants.

In a further-preferred embodiment, the invention provides an insecticidal solid-state composition in the form of water-dispersible granules comprising:
a. compound of the formula (I) selected from the following compounds:

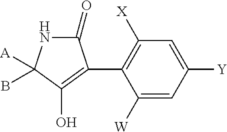

(I)

| | | | | |
|---|---|---|---|---|
| W | X | Y | A | B |

| | | | |
|---|---|---|---|
| CH₃ | CH₃ | CH₃ | 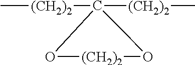 |
| CH₃ | CH₃ | Cl | 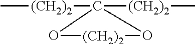 |
| CH₃ | CH₃ | Br | 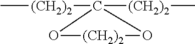 |
| CH₃ | CH₃ | CH₃ | 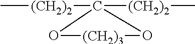 |
| CH₃ | CH₃ | Cl | 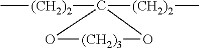 |
| CH₃ | CH₃ | Br | 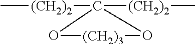 |

### I)

b. at least one inorganic basic ammonium salt selected from the group comprising diammonium hydrogenphosphate (DAHP),
c. at least one inorganic hydrogencarbonate salt where the cation is not ammonium,
d. at least one dispersant of the polycarboxylate type selected from the group comprising hydrophobically modified comb-like polymers comprising polyacrylic acid, polymethacrylic acid, polymaleic acid, polymaleic anhydride, a copolymer of maleic acid or maleic anhydride with an olefin, a copolymer of acrylic acid and itaconic acid, a copolymer of methacrylic acid and itaconic acid, a copolymer of maleic acid or maleic anhydride and styrene and modified copolymers of maleic acid or maleic anhydride and styrene, a copolymer of acrylic acid and methacrylic acid, a copolymer of styrene and methacrylic acid, modified copolymers of styrene and methacrylic acid, a copolymer of acrylic acid and methacrylate, a copolymer of acrylic acid and vinyl acetate, a copolymer of maleic acid or maleic anhydride and acrylic acid, an N-methyl fatty acid (e.g. C₈-C₁₈)-sarcosinate, a carboxylic acid such as a resin acid or a fatty acid (e.g. C₈-C₁₈) or a salt of such a carboxylic acid, and the salts of these copolymers,
e. at least one anionic wetting agent selected from the group consisting of the sodium salts of alkylated naphthalenesulfonates and the sodium salts of dioctylsulfosuccinic acid,
f. at least one inert filler selected from the group comprising carbonates, silicates and oxides, and also urea-formaldehyde condensates and celluloses,
g. optionally a structure former selected from the group comprising polyacrylic acid and salts thereof, crosslinked polyacrylates and polyureas, polyurethanes and derivatized polyureas and polyurethanes,
h. optionally further active insecticidal ingredients,
i. optionally further adjuvants.

In a particularly preferred embodiment, the invention provides an insecticidal solid-state composition in the form of water-dispersible granules comprising:
a. compound having the formula (I-2) having the following structure:

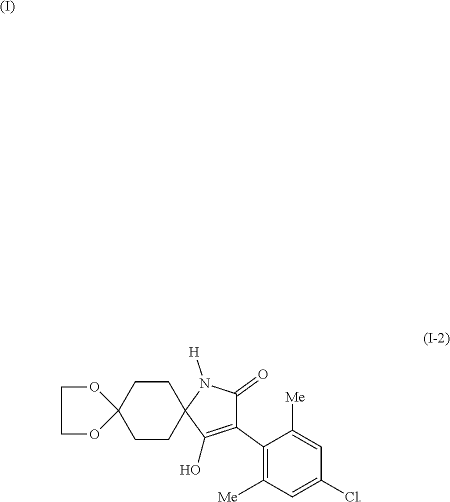 [SMILES: "(I)" ; Cc1cc(Cl)cc(C)c1C1=C(O)C2(CCC3(CC2)OCCO3)NC1=O]

### I)

b. at least one inorganic basic ammonium salt selected from the group comprising diammonium
hydrogenphosphate (DAHP),
c. at least one inorganic hydrogencarbonate salt selected from the group comprising sodium
hydrogencarbonate and potassium hydrogencarbonate,
d. at least one dispersant selected from the group comprising sodium salts of copolymers of
methacrylic acid and styrene and modified copolymers of methacrylic acid and styrene,
e. at least one anionic wetting agent selected from the group consisting of the sodium salts of
alkylated naphthalenesulfonates and the sodium salts of dioctylsulfosuccinic acid,
f. at least one inert filler selected from the group comprising kaolin, rutile and silicon dioxide,
g. optionally a structure former selected from the group comprising polymethylurea resins,
h. optionally further active insecticidal ingredients,
i. optionally further adjuvants.

In an alternative embodiment, in the abovementioned embodiments, a further active insecticidal ingredient (g) is necessarily present, preferably selected from the group comprising imidacloprid, nitenpyram, acetamiprid, thiacloprid, thiamethoxam, clothianidin, cyantraniliprole, chlorantraniliprole, deltamethrin, flubendiamid, tetraniliprole, cyclaniliprole; spirodiclofen, spiromesifen, spirotetramat, abamectin, acrinathrin, chlorfenapyr, emamectin, ethiprole, fipronil, flonicamid, flupyradifuron, indoxacarb, metaflumizone, methoxyfenozid, milbemycin, pyridaben, pyridalyl, silafluofen, spinosad, spinetoram, sulfoxaflor, triflumuron; more preferably from the group comprising ethiprole, spinetoram, abamectin and flupyradifuron.

In an alternative embodiment, in the embodiments mentioned above and also those specified hereinafter, a further adjuvant i), preferably a silicone oil-based defoamer, further preferably polydimethylsiloxane absorbed on a solid substrate, is obligatory.

Solo formulations:

The proportion of the active ingredient (component a/compounds of the formula I/I-2) in the compositions according to the invention with just one active ingredient is
preferably 0.5-25% by weight,
further preferably 1-18% by weight, and
more preferably 2-12% by weight.

The proportion of the salt (component b) in the compositions according to the invention with just one active ingredient is
preferably 20-75% by weight,
further preferably 25-68% by weight, and
more preferably 30-66% by weight.

The proportion of the inorganic salt (component c) in the compositions according to the invention with just one active ingredient is
preferably 1-10% by weight,
further preferably 1.5-9% by weight, and
more preferably 2-7% by weight.

The proportion of the dispersant (component d) in the compositions according to the invention with just one active ingredient is
preferably 1-20% by weight,
further preferably 5-15% by weight, and
more preferably 8-12% by weight.

The proportion of the wetting agent (component e) in the compositions according to the invention with just one active ingredient is
preferably 0.5-15% by weight,
further preferably 1-10% by weight, and
more preferably 1.5-2.5% by weight.

The proportion of the filler (component f) in the compositions according to the invention with just one active ingredient is
preferably 0.5-30% by weight,
further preferably 5-25% by weight, and
more preferably 10-22% by weight.

The proportion of the structure former (component g) in the compositions according to the invention with just one active ingredient is
preferably 0.5-15% by weight,
further preferably 1-10% by weight, and
more preferably 3-8% by weight.

The proportion of the further adjuvants (component i)—if present—in the compositions according to the invention is
preferably 0-10% by weight,
further preferably 0-8% by weight, and
more preferably 0-5% by weight.

If component i) is obligatory in the alternative embodiment, for example as defoamer, the proportion thereof in the solid-state formulations according to the invention is 0.1-5% by weight.

A preferred embodiment of the invention is compositions comprising components
a) 0.5-25% by weight
b) 20-75% by weight
c) 1-10% by weight
d) 1-20% by weight
e) 0.5-15% by weight
f) 0.5-30% by weight
g) 0.5-15% by weight.

A further-preferred embodiment of the invention is compositions comprising components
a) 1-18% by weight
b) 25-68% by weight
c) 1.5-9% by weight
d) 5-15% by weight
e) 1-10% by weight
f) 5-25% by weight
g) 1-10% by weight.

An even further-preferred embodiment of the invention is compositions comprising components
a) 2-12% by weight
b) 30-66% by weight
c) 2-7% by weight
d) 8-12% by weight
e) 1.5-2.5% by weight
f) 10-22% by weight
g) 3-8% by weight.

In an alternative embodiment in which component i) is obligatory, preference is given to a solid-state composition comprising the following components:
a) 2-12% by weight
b) 30-66% by weight
c) 2-7% by weight
d) 8-12% by weight
e) 1.5-2.5% by weight
f) 10-22% by weight
g) 3-8% by weight.
i) 0.1-5% by weight.

Mixture formulations:

The proportion of the further active ingredients (component h)—if present—in the compositions according to the invention is
preferably 1-30% by weight,
further preferably 1-25% by weight, and
more preferably 1.5-20% by weight.

In an alternative embodiment in which components h) and i) are obligatory, preference is given to a solid-state composition comprising the following components:
a) 2-12% by weight
b) 30-66% by weight
c) 2-7% by weight
d) 8-12% by weight
e) 1.5-2.5% by weight
f) 10-22% by weight
g) 3-8% by weight.
h) 1.5-20% by weight
i) 0.1-5% by weight.

Usable with specific preference in the aforementioned compositions are tetramic acid derivatives of the abovementioned formula (I) with G=hydrogen (a).

Likewise most preferably usable are tetramic acid derivatives of the formula (I) mentioned above where G=E (d).

Compound I-2 is preferably used in the form of its most thermodynamically stable polymorphous structure. This crystal structure and further physical data were determined as follows:

### Sample Preparation:

Compound I-2 (C₁₉H₂₂ClNO₄/MW=363.84 g/mol) was crystallized from methanol and dried at room temperature, giving modification A.

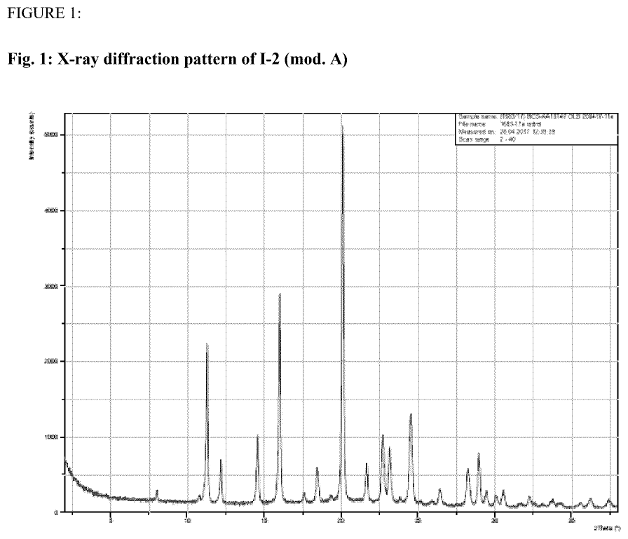

Modification A of I-2 can be characterized by x-ray powder diffractometry based on the corresponding diffraction diagrams that were recorded at 25° C. and with Cu-Kα 1 radiation (1.5406 Å) (FIG. 1).

Modification A according to the present invention shows at least 3, preferably at least 5, further preferably at least 7, even further preferably at least 10 and most preferably all reflections as shown in FIG. 1 and table 2a). Table 2b) shows all the measured reflections of modification A:

Modification A according to the present invention is further characterized by the x-ray diffraction diagram shown in Figure I.

Crystallographic studies on single crystals of modification A showed that the crystal structure is monoclinic. The unit cell has the P2₁/c space group.

TABLE 2
Crystallographic properties of modification A

| | |
|---|---|
| Parameter | Polymorph A |
| Crystal system | monoclinic |
| Space group | P2₁/c |
| a in Å | 11.66544(14) |
| b in Å | 9.50603(10) |
| c in Å | 16.66907(19) |
| α | 90 |
| β | 110.2045(13) |
| γ | 90 |
| Z | 4 |
| Density (calculated) | 1.393 g/cm³ |

a, b, c = length of the sides of the unit cell
α, β, γ = angles of the unit cell
Z = number of molecules in the unit cell

TABLE 2a/b
Crystallographic data/reflections [°2theta] of polymorph A

| | 2b |
|---|---|
| 2a | Reflections |
| [°2theta] | [°2theta] |
| Polymorph A | Polymorph A |
| 11.3 | 8.0 |
| 14.6 | 10.8 |
| 16.0 | 11.3 |
| 20.1 | 12.2 |
| 21.7 | 14.6 |
| 22.7 | 16.0 |
| 23.1 | 17.6 |
| 24.5 | 18.4 |
| 28.2 | 19.4 |
| 29.0 | 20.1 |
| | 21.7 |
| | 22.7 |
| | 23.1 |
| | 23.8 |
| | 24.5 |
| | 25.9 |
| | 26.4 |
| | 28.2 |
| | 29.0 |
| | 29.4 |
| | 30.1 |
| | 30.6 |
| | 32.2 |
| | 36.2 |
| | 37.4 |
| | 38.2 |
| | 39.1 |

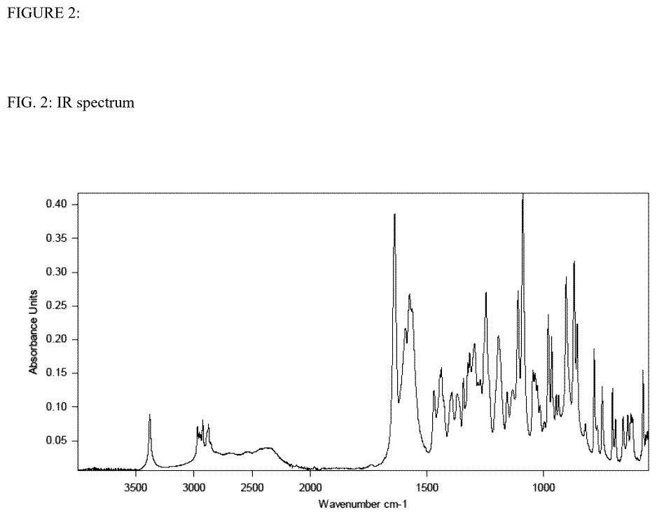

The polymorphic form of polymorph A of I-1 can be determined by IR spectroscopy from the corresponding spectrum which has been recorded at 25° C. using a diamond ATR instrument at a resolution of 4 cm-1 (FIG. 2). Polymorph A of the present invention shows at least 3, preferably at least 5, further preferably at least 7 and especially preferably all bands as can be seen in FIG. 2 and are described in table 2c.

TABLE 2c
IR bands [cm⁻¹]

| Band maxima | |
|---|---|
| [cm⁻¹] | Band maxima |
| Polymorph A | [cm⁻¹] |
| 3378 | 1133 |
| 2969 | 1109 |
| 2955 | 1088 |
| 2943 | 1045 |
| 2924 | 1036 |
| 2876 | 1027 |
| 2858 | 1015 |
| 2326 | 997 |
| 1637 | 980 |
| 1592 | 965 |
| 1575 | 946 |
| 1564 | 936 |
| 1470 | 903 |
| 1444 | 869 |
| 1438 | 856 |
| 1428 | 821 |
| 1394 | 783 |
| 1372 | 769 |
| 1344 | 748 |
| 1325 | 704 |
| 1317 | 691 |
| 1297 | 659 |
| 1272 | 639 |
| 1247 | 625 |
| 1194 | 573 |
| 1157 | 563 |
| | 553 |

In addition to the above-described polymorph A, compound I-2 may be present in further polymorphous forms and also pseudopolymorphous forms (hydrates, solvates, etc.).

The application rate of the formulations of the invention can be varied within a relatively wide range. It is guided by the respective active ingredients and by the content thereof in the compositions.

With the aid of the compositions of the invention, the insecticidal active ingredient mixtures can be deployed in a particularly advantageous manner on plants and/or their habitat.

The compositions of the invention can be used to treat all plants and parts of plants. Plants in this context are understood to include all plants and plant populations, such as desired and unwanted wild plants or crop plants (including naturally occurring crop plants). Crop plants may be plants which can be obtained by conventional breeding and optimization methods or by biotechnological and genetic engineering methods or combinations of these methods, including the transgenic plants and including the plant cultivars which are protectable or non-protectable by plant breeders' rights. Parts of plants shall be understood to mean all parts and organs of the plants above and below ground, such as shoot, leaf, flower and root, examples given being leaves, needles, stalks, stems, flowers, fruit bodies, fruits and seeds, and also tubers, roots and rhizomes. Plant parts also include harvested material and vegetative and generative propagation material, for example cuttings, tubers, rhizomes, shoots and seeds.

Preferably, the compounds of the formula (I) are used in the formulations according to the invention by spray application, but also after drench, dip or drip application, against animal pests from the following pest families:

Preference is given from the family of the woolly aphids (Pemphigidae) to: Eriosoma spp., Pemphigus spp., in crops such as, for example, citrus fruit, pome fruit, stone fruit, leaf vegetables, root and tuber vegetables and ornamental plants.

Preference is given from the family of the grape lice (Phylloxeridae) to: Phylloxera spp. in grapevines, nuts, citrus fruit.

Preference is given from the family of the jumping plant lice (Psyllidae) to: Psylla spp., Paratrioza spp., Tenalaphara spp., Diaphorina spp., Trioza spp., in crops such as, for example, pome fruit, stone fruit, citrus fruit, vegetables, potatoes, in tropical crops.

Preference is given, from the family of the soft scales (Coccidae), to: Ceroplastes spp., Drosicha spp., Pulvinaria spp., Protopulminaria spp., Saissetia spp., Coccus spp., in perennial crops, for example citrus fruit, pome fruit, stone fruit, olives, grapes, coffee, tea, tropical crops, ornamentals, vegetables.

Preference is given, from the family of the armoured scale insects (Diaspididae), to: Quadraspidiotus spp., Aonidiella spp., Lepidosaphes spp., Aspidiotus spp., Aspis spp., Diaspis spp., Parlatoria spp., Pseudaulacaspis spp., Unaspis spp., Pinnaspis spp., Selenaspidus spp., in crops such as, for example, citrus fruit, pome fruit, stone fruit, almonds, pistachios, nuts, olives, tea, ornamental plants, grapevines, tropical crops.

Preference is given from the family of the ensign scales (Ortheziidae) to: Orthezia spp. in citrus fruit, pome fruit, stone fruit.

Preference is given, from the family of the mealy bugs (Pseudococcidae), to: Pericerga, Pseudococcus spp., Planococcus spp., Dysmicoccus spp., in crops such as, for example, citrus fruit, stone fruit and pome fruit, tea, grapes, vegetables, ornamentals and tropical crops.

Preference is further given, from the family of the whiteflies (Aleyrodidae), to: Bemisia tabaci, Bemisia argentifolii, Trialeurodes vaporariorum, Aleurothrixus floccosus, Aleurodes spp., Dialeurodes spp., Parabemisia myricae in crops such as, for example, vegetables, melons, potatoes, tobacco, soft fruit, citrus fruit, ornamental plants, cotton, soya beans and tropical crops.

Moreover, preference is given from the family of the aphids (Aphidae) to: Myzus spp. in tobacco, stone fruit, soft fruit, fruit vegetables, leaf vegetables, tuber and root vegetables, melons, potatoes, ornamental plants, spices,
Acyrthosiphon onobrychis in vegetables,
Aphis spp. in tobacco, citrus fruit, pome fruit, stone fruit, melons, strawberries, soft fruit, fruit vegetables, leaf vegetables, tuber, stem and root vegetables, ornamental plants, potatoes, pumpkins, spices,
Rhodobium porosum in strawberries,
Nasonovia ribisnigri in leaf vegetables,
Macrosiphum spp. in ornamental plants, potatoes, leaf vegetables and fruit vegetables, strawberries,
Phorodon humuli in hops,
Brevicoryne brassicae in leaf vegetables,
Toxoptera spp. in citrus fruit, stone fruit, almonds, nuts, spices,
Aulacorthum spp. in citrus fruit, potatoes, fruit vegetables and leaf vegetables,
Anuraphis cardui in vegetables,
Brachycaudus helycrisii in sunflowers,
Acyrthosiphon onobrychis in vegetables.

Likewise, preference is given from the family of the thrips (Thripidae) to: Anaphothrips spp., Baliothrips spp., Caliothrips spp., Frankliniella spp., Heliothrips spp., Hercinothrips spp., Rhipiphorothrips spp., Scirtothrips spp., Kakothrips spp., Selenothrips spp, and Thrips spp., in crops such as, for example, fruit, cotton, grapevines, tea, nuts, tropical crops, ornamental plants, conifers, tobacco, spices, vegetables, soft fruit, melons, citrus fruit and potatoes.

Moreover, preference is given from the families of the leaf-miner flies (Agromyzidae) and root-maggot flies (Anthomyiidae) to: Agromyza spp., Amauromyza spp., Atherigona spp., Chlorops spp., Liriomyza spp., Oscinella spp., Pegomyia spp. in crops such as, for example, vegetables, melons, potatoes, nuts, ornamental plants.

Preference is given from the families of the leafhoppers (Cicadellidae) and planthoppers (Delphacidae) to: Circulifer spp., Dalbus spp., Empoasca spp., Erythroneura spp., Homalodisca spp., Iodioscopus spp., Laodelphax spp., Nephotettix spp., Nilaparvata spp., Oncometopia spp., Sogatella spp., in crops such as, for example, citrus fruit, fruit, grapevines, potatoes, vegetables, ornamental plants, conifers, melons, soft fruit, tea, nuts, rice and tropical crops.

Preference is given from the family of the leaf-miner moths (Gracillariidae) to: Caloptilia spp., Gracillaria spp., Lithocolletis spp., Leucoptera spp., Phtorimaea spp., Phyllocnistis spp. in crops such as pome fruit, stone fruit, grapes, nuts, citrus fruit, conifers, potatoes, coffee.

Preference is given from the family of the gall midges (Cecidomyiidae) to: Contarinia spp., Dasineura spp., Diplosis spp., Prodiplosis spp., Thecodiplosis spp., Sitodiplosis spp., Haplodiplosis spp. in crops such as citrus fruit, pome fruit, stone fruit, vegetables, potatoes, spices, soft fruit, conifers, hops.

Likewise, preference is given from the family of the fruit flies (Tephritidae) to: Anastrepha spp., Ceratitis spp., Dacus spp., Rhagoletis spp. in crops such as vegetables, soft fruit, melons, pomaceous and stone fruit, ornamental plants, potatoes, grapevines, tropical crops, citrus fruit, olives.

Moreover, preference is given to mites from the families of the spider mites (Tetranychidae) and the gall mites (Eriophydae):
Tetranychus spp., Panonychus spp., Aculops spp. in crops such as vegetables, potatoes, ornamental plants, citrus fruit, grapevines, conifers.

The inventive treatment of the plants and parts of plants with the compositions of the invention is effected directly or by allowing the compositions to act on their surroundings, environment or storage space by the customary treatment methods, for example by drenching, immersion, spraying, evaporation, fogging, scattering, painting on and, in the case of propagation material, in particular in the case of seeds, also by applying one or more coats.

The active ingredient is preferably applied by spray application. Alternatively, the active ingredient is applied by drench, drip or dip application.

Preferably, the plant to be treated is selected from the group consisting of cotton, soya beans, tobacco, vegetables, spices, ornamental plants, conifers, citrus plants, fruit, tropical crops, nuts and grapevines.

Preferably, the composition of the invention acts against pests from the families of the woolly aphids, grape lice, jumping plant lice, soft scales, armoured scale insects, ensign scales, mealy bugs, whiteflies, aphids, thrips, leafhoppers, planthoppers, leaf-miner flies, gall midges, fruit flies, leaf-miner moths, spider mites, gall mites.

It has also been found that the compositions according to the invention can be produced by moistening a pulverulent mixture consisting of the active ingredient(s) and the formulation auxiliaries, then granulating by means of low-pressure extrusion and then drying the moist granules. Relevant equipment for the moistening, extrusion and drying is known to those skilled in the art. In the course of production, it should especially be ensured that the temperatures to which the product is exposed are kept lower than 60° C. and preferably lower than 50° C. in all process steps.

This process too forms part of the subject-matter of the invention.

The inventive treatment of the plants and parts of plants with the compositions according to the invention is effected directly or by allowing the combinations to act on the surroundings, environment or storage space by the customary treatment methods, for example by dipping, spraying, evaporation, fogging, scattering, painting on and, in the case of propagation material, in particular in the case of seeds, also by applying one or more coats.

The examples which follow illustrate the subject-matter of the invention without limiting it.

### EXAMPLES

### 1 Sample Production and Physical Characteristics

1 kg of a mixture of compound I-2, optionally a second active ingredient, diammonium hydrogenphosphate (DAHP), (optionally) a second inorganic salt, Morwet EFW, Pergopak M, kaolin W, dispersing aids, optionally additionally magnesium stearate, and defoamers, in the manner known to the person skilled in the art, was ground in a Hosokawa 100 AS 4″ air-jet mill (injector air 5.5 bar, grinding air 4.5 bar, throughput 100 g/min), moistened with water (about 14% by weight) and extruded using a Fuji Paudal dome extruder (die size 1 mm) to give a WG, and dried further in a fluidized bed dryer.

Composition examples

| Example | #1 | #2 | #3 | #4 | #5 | #6 | #7 |
|---|---|---|---|---|---|---|---|
| Inventive | Com- | x | x | x | x | Ver- | x |
| | parative | | | | | gleich | |
| 1-2 [g] | 7.2 | 7.2 | 7.2 | 7.2 | 7.2 | 7.2 | 7.2 |
| Flupyradi- | 15 | 15 | 15 | 15 | 15 | 15 | 15 |
| furone/[g] | | | | | | | |
| DAHP/[g] | 44 | 41.5 | 39 | 34 | 34 | 29 | 34 |
| Potassium | | 2.5 | 5 | 10 | 10 | 15 | |
| hydrogen- | | | | | | | |
| carbonate/ | | | | | | | |
| [g] | | | | | | | |
| Sodium | | | | | | | 10 |
| hydrogen | | | | | | | |
| carbonate/ | | | | | | | |
| [g] | | | | | | | |
| Morwet | 2 | 2 | 2 | 2 | 2 | 2 | 2 |
| EFW/[g] | | | | | | | |
| Pergopak | 5 | 5 | 5 | 5 | 5 | 5 | 5 |
| M/[g] | | | | | | | |
| Kaolin | 15.8 | 15.3 | 15.3 | 15.8 | 15.3 | 15 | 15.8 |
| W/[g] | | | | | | | |
| Atlox | 10 | 10 | 10 | 10 | 10 | 10 | 10 |
| Metasperse | | | | | | | |
| 550S/[g] | | | | | | | |
| Magnesium | | 0.5 | 0.5 | | 0.5 | 0.5 | |
| stearate/[g] | | | | | | | |
| Rhodorsil | 1 | 1 | 1 | 1 | 1 | 1 | 1 |
| antifoam EP | | | | | | | |
| 6703/[g] | | | | | | | |
| Producibility | + | + | + | + | + | + | (+) |
| Visual | + | + | + | + | + | + | + |
| assessment | | | | | | | |

Examples of storage data

| | | #1 | #2 | #3 | #4 | #5 | #6 | #7 |
|---|---|---|---|---|---|---|---|---|
| pH | Initial | 7.6 | 7.5 | 7.5 | 7.4 | 7.4 | 7.5 | 7.7 |
| | 4W 54° C. | 7.6 | 7.5 | 7.3 | 7.1 | 7.1 | 6.9 | 7.5 |
| | 26W RT | 7.6 | 7.4 | 7.5 | 7.2 | 7.3 | 7.1 | 7.5 |
| Suspend- | Initial | 96 | 97.6 | 96.8 | 96.7 | 96.8 | 97.4 | 97.7 |
| ability/[%] | | | | | | | | |
| | 4W 54° C. | 95.2 | 96.9 | 96.4 | 96.8 | 96.5 | 96.1 | 95.1 |
| | 26W RT | 94.5 | 97.3 | 97.0 | 97.3 | 96.6 | 97.4 | 96.7 |
| Wet sieve | Initial | 0.028 | 0.01 | 0.016 | 0.036 | 0.032 | 0.024 | 0.032 |
| residue | | | | | | | | |
| (45 μm | | | | | | | | |
| sieve)/[%] | | | | | | | | |
| | 4W 54° C. | 0.048 | 0.04 | 0.040 | 0.025 | 0.025 | 0.030 | 0.035 |
| | 26W RT | 0.128 | 0.015 | 0.025 | 0.055 | 0.015 | 0.025 | 0.060 |
| Sediment [%] | Initial | 13.6 | 12.1 | 12.8 | 12.9 | 12.8 | 12.2 | 12.0 |
| | | (some | | | | | | |
| | | granules | | | | | | |
| | | do not | | | | | | |
| | | break | | | | | | |
| | | down) | | | | | | |
| | 4W 54° C. | 14.2 | 12.7 | 13.2 | 12.8 | 13.1 | 13.4 | 14.3 |
| | | (some | | | | | | |
| | | granules | | | | | | |
| | | do not | | | | | | |
| | | break | | | | | | |
| | | down) | | | | | | |
| | 26W RT | 14.8 | 12.3 | 12.6 | 12.3 | 13.0 | 12.3 | 12.9 |
| | | (some | | | | | | |
| | | granules | | | | | | |
| | | do not | | | | | | |
| | | break | | | | | | |
| | | down) | | | | | | |

Composition examples

| Example | #8 | #9 | #10 | \|#11 | #12 | #13 | #14 | #15 | #16 | #17 | #18 | #19 | #20 | #21 | #22 |
|---|---|---|---|---|---|---|---|---|---|---|---|---|---|---|---|
| Inventive | x | x | x | x | x | x | x | x | x | x | x | x | x | x | x |
| I-2 [g] | 4.8 | 10.8 | 9.6 | 9.6 | 12 | 3.6 | 3.6 | 10.8 | 9.6 | 9.6 | 9.6 | 12 | 12 | 12 | 4.8 |
| Abamectin | | | | | | 1.8 | 1.8 | | | | | | | | |
| Spinetoram | | 7.5 | 12 | 12 | 9 | | | 7.5 | 12 | 12 | 12 | 9 | 9 | 8 | |
| DAHP/[g] | 62.5 | 45.4 | 42.1 | 42.1 | 42.1 | 55.8 | 55.8 | 45.4 | 42.1 | 42.1 | 42.1 | 42.1 | 42.1 | 42.1 | 63.5 |
| Potassium | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| hydrogen- | | | | | | | | | | | | | | | |
| carbonate/[g] | | | | | | | | | | | | | | | |
| Morwet EFW/ | 2 | 2 | 2 | | 2 | 2 | 2 | 2 | | | | | | | 2 |
| [g] | | | | | | | | | | | | | | | |
| Geropon SDS/ | | | | 1 + | | | | | 2 + | 2 + | | 2 + | 2 + | 2 + | |
| Geropon TA/72 | | | | 0.5 | | | | | 0 | 0 | | 0 | 0 | 0 | |
| [g] | | | | | | | | | | | | | | | |
| Geropon L-Wet | | | | | | | | | | | 2 | | | | |
| Max [g] | | | | | | | | | | | | | | | |
| Pergopak M/[g] | 5 | 5 | 5 | 5 | 5 | 5 | 5 | 5 | 5 | 5 | 5 | 5 | 5 | 5 | 5 |
| Kaolin W/[g] | 11.7 | 15.3 | 15.3 | 15.8 | 15.9 | 17.8 | 18.8 | 15.3 | 16.3 | 15.3 | 16.3 | 16.9 | 15.9 | 17.9 | 11.7 |
| Tersperse 2700/ | 10 | | | | | | | | | | | | | | 10 |
| [g] | | | | | | | | | | | | | | | |
| Atlox | | 10 | 10 | 10 | 10 | 10 | 10 | 10 | 10 | 10 | 10 | 10 | 10 | 10 | |
| Metasperse 550S/ | | | | | | | | | | | | | | | |
| [g] | | | | | | | | | | | | | | | |
| Magnesium | | 0.5 | 0.5 | 0.5 | 0.5 | 0.5 | 0.5 | 0.5 | 0.5 | 0.5 | 0.5 | 0.5 | 0.5 | 0.5 | |
| stearate/[g] | | | | | | | | | | | | | | | |
| Trilon B Powder/ | 0.5 | | | | | | | | | | | | | | 0.5 |
| [g] | | | | | | | | | | | | | | | |
| Rhodorsil | 1 | 1 | 1 | 1 | 1 | 1 | | 1 | | 1 | | | 1 | | |
| antifoam EP | | | | | | | | | | | | | | | |
| 6703/[g] | | | | | | | | | | | | | | | |
| Producibility | + | + | + | + | + | + | + | + | + | + | + | + | + | + | + |
| Visual | + | + | + | + | + | + | + | + | + | + | + | + | + | + | + |
| assessment | | | | | | | | | | | | | | | |
| Storage stability | + | + | + | (+) | + | + | + | + | + | + | + | + | + | + | + |

Determination of pH (by Method CIPAC MT 75.3):

pH is determined with a standard pH glass electrode in a 1% dispersion of the granules in demineralized water at 23° C.

Determination of Suspendability (by Method CIPAC MT 184.1):

A 1% suspension in water (CIPAC C) is dispersed in a 250 ml measuring cylinder. The mixture is equilibrated for 30 minutes. Subsequently, the upper 9/10 of the suspension is removed. The remaining 1/10 is dried and the residue (sediment) is determined gravimetrically. Suspendability is defined as:

$$10 / 9 * 100 * ( amount of sample [ g ] * proportion a . i . [ \% ] / 100 - residue [ g ] ) / ( amount of sample [ g ] * proportion a . i . [ \% ] / 100 )$$

Thus, a value of 100% corresponds to a homogeneous distribution of all insoluble constituents throughout the sample volume.

Determination of wet sieve residue (by method CIPAC MT 185):

25 g of granules is introduced into 250 ml of water in a beaker. After one minute, the mixture is stirred with a magnetic stirrer for 5 minutes. Subsequently, the dispersion and the wash water are transferred onto the corresponding sieve for the cleaning of the beaker. The sieve is then rinsed through with cold water until there is no longer any apparent change in the residue on the sieve (max. 10 min). After the sieve has dripped dry, the residue is transferred quantitatively to an evaporation dish with demineralized water and left to dry, and the residue is determined gravimetrically.

2. Use examples:
The producibility test for a pre-slurry for the spray applications was conducted with an induction hopper under the following boundary conditions: Tank volume: 400 1
Volume of water: 100 1
Amount of granules: 2.5 kg

While the water was being pumped in circulation, the 2.5 kg of product was introduced rapidly into the induction hopper and pumped in circulation for a further 10 min. After 5 and after 10 min, residue in the induction hopper, the filter in the intake and the residue of undispersed product in the tank were inspected.

| | Time | | | | | |
|---|---|---|---|---|---|---|
| | until | Residues in test equipment | | | | |
| | the | Induction | | | Resi- | |
| | product | hopper | | | due | |
| | had | after | Intake | Intake | undis- | |
| | been | further | filter, | filter, | persed | |
| | flushed | flush | [%] | [%] | of | |
| | out | with | cover- | cover- | product | |
| Ex- | of the | 3 1 of | age | age | in the | As- |
| am- | hopper | water | after | after | tank | sess- |
| ple | [s] | [%] | 5 min | 10 min | [%] | ment |
| #1 | 45 | 1 | 40 | (not | \|20 | (−) |
| | | | | poss- | | |
| | | | | ible) | | |
| #2 | 50 | 0 | 10 | 0 | <1 | (+) |

### Materials Used

Geropon® TA/72 is a polycarboxylic acid sodium salt, Geropon® SDS a dioctyl sodium sulfosuccinate, and Geropon R L-Wet max a blend from Solvay.

Kaolin W is an aluminium hydrosilicate from Erbslöh Lohrheim GmbH & Co. KG, Lohrheim, Germany.

Tersperse® 2700 is a naphthalenesulfonic acid-formaldehyde condensate, sodium salt from Indorama Ventures, The Woodlands, Texas, USA.

Rhodorsil antifoam EP 6703® is an absorbed polydimethylsiloxane, Solvay.

Morwet EFW is an alkylnaphthalenesulfonate sodium salt from Nouryon, Stenungsund, Sweden.

Pergopak® M is a polymethylurea resin from Huber Martinswerk, Bergheim, Germany.

Atlox Metasperse™ 550S is a modified styrene-acrylic polymer from Croda, Great Britain.

Trilon R B powder is a tetrasodium ethylenediaminetetraacetate from BTC Europe GmbH, Monheim, Germany.

Flupyradifuron is a crop protection active from Bayer Crop Science.

Abamectin is a crop protection active from Syngenta.

Spinetoram is a crop protection active from Corteva.

1. A solid-state composition of water-dispersible granules comprising:
a. tetramic acid derivatives of formula (I) 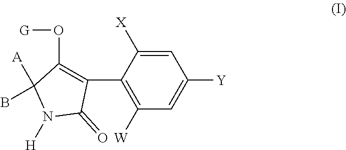
in which
W and Y are independently hydrogen, C₁-C₄-alkyl, chlorine, bromine, iodine or fluorine, X is C₁-C₄-alkyl, C₁-C₄-alkoxy, chlorine, bromine or iodine,
A, B and the carbon atom to which they are bonded are C3-C6-cycloalkyl substituted by an C1-C4-alkyl- or C1-C4-alkoxy-C1-C2-alkyl-substituted alkylenedioxyl group that forms a 5-membered or 6-membered ketal together with the carbon atom to which it is bonded,
G is hydrogen (a) or one of (b), (c), or (d) below: 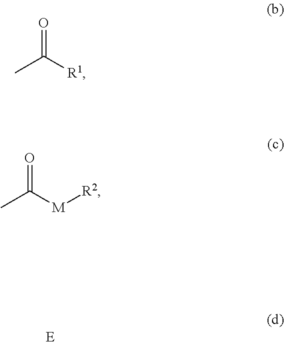
in which
E is a metal ion or an ammonium ion,
M is oxygen or sulfur,
R¹ is straight-chain or branched C1-C6-alkyl,
R² is straight-chain or branched C1-C6-alkyl;
b. at least one basic salt;
c. at least one further inorganic salt from the group of the carbonates and hydrogencarbonates;
d. at least one dispersant;
e. at least one wetting agent;
f. at least one filler; and
g. at least one structure former.

2. The composition according to claim 1, further comprising:
h, at least one further active ingredient.

3. The composition according to claim 1,
wherein G is hydrogen (a), with

| | | | | |
|---|---|---|---|---|
| W | X | Y | A | B |
| | | | |
|---|---|---|---|
| CH₃ | CH₃ | CH₃ | 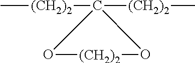 |
| CH₃ | CH₃ | Cl | 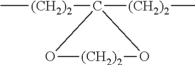 |
| CH₃ | CH₃ | Br | 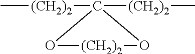 |
| CH₃ | CH₃ | CH₃ | 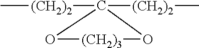 |
| CH₃ | CH₃ | Cl | 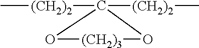 |
| CH₃ | CH₃ | Br | 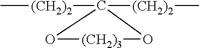 |

4. The composition according to claim 1, wherein component a. is a compound of formula (I-2):

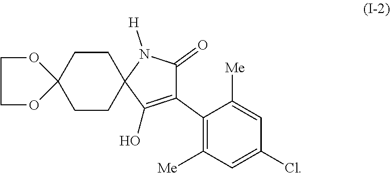 [SMILES: Cc1cc(Cl)cc(C)c1C1=C(O)C2(CCC3(CC2)OCCO3)NC1=O]

5. The composition according to claim 1, wherein component b, is diammonium hydrogenphosphate (DAHP).

6. The composition according to claim 1, wherein component c, is selected from the group consisting of sodium hydrogencarbonate and potassium hydrogencarbonate.

7. The composition according to claim 1, wherein component d, is selected from the group consisting of sodium salts of copolymers of maleic acid and olefins, and sodium salts of copolymers of methacrylic acid and styrene, modified copolymers of methacrylic acid and styrene.

8. The composition according to claim 1, wherein component e, is selected from the group consisting of sodium salts of alkylated naphthalenesulfonates and the sodium salts of dioctylsulfosuccinic acid.

9. The composition according to claim 1, wherein component f, is selected from the group consisting of kaolin, rutile and silicon dioxide.

10. The composition according to claim 1, wherein component g, a polymethylurea resin.

11. The composition according to claim 2, wherein component h, is selected from the group consisting of imidacloprid, nitenpyram, acetamiprid, thiacloprid, thiamethoxam, clothianidin, cyantraniliprole, chlorantraniliprole, deltamethrin, flubendiamid, tetraniliprole, cyclaniliprole; spirodiclofen, spiromesifen, spirotetramat, abamectin, acrinathrin, chlorfenapyr, emamectin, ethiprole, fipronil, flonicamid, flupyradifuron, indoxacarb, metaflumizone, methoxyfenozid, milbemycin, pyridaben, pyridalyl, silafluofen, spinosad, spinetoram, sulfoxaflor, triflumuron; more preferably from the group comprising ethiprole, spinetoram, abamectin and flupyradifurone.

12. The composition according to claim 1,
wherein
W is methyl,
X is chlorine or methyl,
Y is chlorine, bromine or methyl,
A, B and the carbon atom to which they are bonded are saturated C6-cycloalkyl substituted by an alkylenedioxyl group that forms a 5-membered or 6-membered ketal together with the carbon atom to which it is bonded,
M is oxygen,
R¹ is straight-chain or branched C₁-C₄-alkyl,
R² is straight-chain or branched C₁-C₄-alkyl,
the composition further comprising:
b. at least one inorganic basic salt;
c. at least one further inorganic salt selected from the group consisting of sodium hydrogencarbonate and potassium hydrogencarbonate;
d. at least one dispersant of the polycarboxylate type;
e. at least one anionic wetting agent; and
f. at least one inert filler

13. The composition according to claim 1, comprising compound of the formula (I) selected from the following compounds: 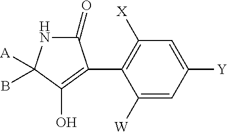
(I)

| | | | | |
|---|---|---|---|---|
| W | X | Y | A | B |
| | | | |
|---|---|---|---|
| CH₃ | CH₃ | CH₃ | 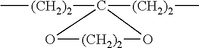 |
| CH₃ | CH₃ | Cl | 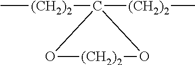 |
| CH₃ | CH₃ | Br | 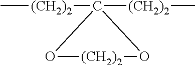 |
| CH₃ | CH₃ | CH₃ | 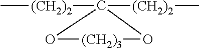 |
| CH₃ | CH₃ | Cl | 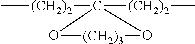 |
| CH₃ | CH₃ | Br | 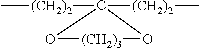 |

the composition further comprising:
b. diammonium hydrogenphosphate (DAHP);
c. at least one further inorganic salt from the group of carbonates and hydrogencarbonates;
d. at least one dispersant of the polycarboxylate type selected from the group of hydrophobically modified comb-like polymers consisting of polyacrylic acid, polymethacrylic acid, polymaleic acid, polymaleic anhydride, a copolymer of maleic acid or maleic anhydride with an olefin, a copolymer of acrylic acid and itaconic acid, a copolymer of methacrylic acid and itaconic acid, a copolymer of maleic acid or maleic anhydride and styrene, a copolymer of acrylic acid and methacrylic acid, a copolymer of acrylic acid and methacrylate, a copolymer of acrylic acid and vinyl acetate, copolymers of methacrylic acid and styrene, modified copolymers of methacrylic acid and styrene, a copolymer of maleic acid or maleic anhydride and acrylic acid, an N-methyl fatty acid (e.g. C₈-C₁₈)-sarcosinate, a carboxylic acid such as a resin acid or a fatty acid (e.g. C₈-C₁₈) or a salt of such a carboxylic acid, and the salts of these copolymers;
e. at least one anionic wetting agent selected from the group consisting of the sodium salts of alkylated naphthalenesulfonates and the sodium salts of dioctylsulfosuccinic acid;
f. at least one inert filler selected from the group consisting of carbonates, silicates, silicon oxides, urea-formaldehyde condensates, and celluloses [,]]; and
g. at least one structure former selected from the group consisting of polyacrylic acid and salts thereof, crosslinked polyacrylates and polyureas, polyurethanes and derivatized polyureas and polyurethanes

14. The composition according to claim 1, comprising a compound of formula (1-2): 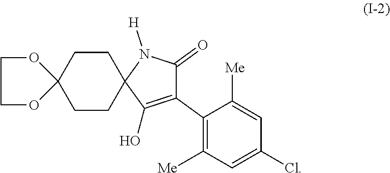 [SMILES: Cc1cc(Cl)cc(C)c1C1=C(O)C2(CCC3(CC2)OCCO3)NC1=O]
the composition further comprising:
b. diammonium hydrogenphosphate (DAHP);
c. at least one inorganic salt selected from the group consisting of sodium hydrogencarbonate and potassium hydrogencarbonate;
d. at least one dispersant selected from the group consisting of sodium salts of copolymers of methacrylic acid and styrene;
e. at least one anionic wetting agent wherein the anionic wetting agent is a sodium salt of an alkylated naphthalenesulfonates;
f. at least one inert filler selected from the group consisting of kaolin, rutile, and silicon dioxide; and
g. at least one structure former, wherein the structure former is a polymethylurea resin

15. The composition according to claim 1, wherein components a.-g. are present as follows:
a. 2-12% by weight;
b. 30-66% by weight;
c. 2-7% by weight;
d. 8-12% by weight:
e. 1.5-2.5% by weight;
f. 10-22% by weight; and
g. 3-8% by weight.

16. The composition according to claim 15, further comprising further active ingredient h, wherein h. is present as follows:
h, 1.5-20% by weight.

17. The composition according to claim 15, further comprising formulation auxiliaries i, wherein i, is present as follows:
i. 0.1-5% by weight.

18. A process for producing a composition according to claim 1, the composition is effected by the process comprising:
mixing the components a.-g.; and
an extruding step.

19. (canceled)

20. (canceled)

21. A method for controlling insects, the method comprising application of the composition of claim 1 to at least one plant.

22. The composition of claim 7, wherein component d. is selected from the group consisting of sodium salts of copolymers of methacrylic acid and styrene and modified copolymers of methacrylic acid and styrene.

23. The composition of claim 8, wherein component e. is a sodium salt of an alkylated naphthalenesulfonate.

24. The composition of claim 9, wherein component f. is kaolin.
